(19) United States
(12) Patent Application Publication
(10) Pub. No.: US 2019/0114865 A1
(43) Pub. Date: Apr. 18, 2019

(54) VALUABLE MEDIUM PROCESSING APPARATUS AND VALUABLE MEDIUM PROCESSING SYSTEM

(71) Applicant: GLORY LTD., Hyogo (JP)

(72) Inventor: Mitsushi NAGAO, Frankfurt am Main (DE)

(21) Appl. No.: 16/158,341

(22) Filed: Oct. 12, 2018

(30) Foreign Application Priority Data
Oct. 13, 2017 (JP) 2017-199833

(51) Int. Cl. G07D 11/00

(52) U.S. Cl. CPC G07D 11/0048; G07D 11/0024; G07D 11/0072; G07D 11/0096; G07D 11/0063; G07D 11/0009

(57) ABSTRACT

A valuable medium processing apparatus comprises: an attaching unit to which a container for storing valuable media is to be detachably mounted; and a control unit that receives a taking-out instruction for the container, and sequentially outputs at least two pieces of valuable medium information about the valuable media stored in the container.

### CROSS REFERENCE TO RELATED APPLICATIONS

This application is entitled to and claims the benefit of Japanese Patent Application No. 2017-199833, filed on Oct. 13, 2017, the disclosure of which including the specification, drawings and abstract is incorporated herein by reference in its entirety.

### TECHNICAL FIELD

The present invention relates to a valuable medium processing apparatus and a valuable medium processing system that perform various processes for valuable media.

### BACKGROUND ART

Valuable medium processing apparatuses include a banknote processing apparatus for processing banknotes, and a money processing apparatus for processing money. The case of the banknote processing apparatus is hereinafter exemplified and described.

For example, as disclosed in International Patent Publication WO2010/021043, extraction of banknotes from the banknote processing apparatus is performed by taking out a container that stores the banknotes. At this time, a voucher is printed on which information about the banknotes stored in the container (e.g., the number of notes of each denomination, and the total amount) is printed or displayed as a barcode. By reading the voucher visually or through a scanner, the information about the banknotes stored in the container can be obtained.

A banknote collecting agency combines, as a set, the container and the voucher on which the information about the banknotes stored in the container is indicated, and takes the set to a cash center. In the cash center, the information on the voucher having been brought back is verified. If there is no problem, a deposit operation for the banknotes in the container having been brought back is performed.

### CITATION LIST

### Patent Literature

### PTL 1

### WO2010/021043

### SUMMARY OF INVENTION

### Technical Problem

In case a failure occurs in a printing machine that prints a voucher or the banknote processing apparatus itself, there is a possibility that the voucher cannot be appropriately printed even though the container has been taken out from the banknote processing apparatus. Consequently, there is a possibility that the collecting agency cannot take the container without any trouble.

The present invention has been made in view of such a situation, and has an object to provide a valuable medium processing apparatus capable of obtaining information about valuable media stored in the container that is to be taken out.

### Solution to Problem

A valuable medium processing apparatus of the present invention includes: an attaching unit to which a container for storing valuable media is to be detachably mounted; and a control unit that receives a taking-out instruction for the container, and sequentially outputs at least two pieces of valuable medium information about the valuable media stored in the container.

### Advantageous Effects of Invention

The present invention can provide a valuable medium processing apparatus capable of obtaining information about valuable media stored in a container that is to be taken out.

### BRIEF DESCRIPTION OF DRAWINGS

FIG. 1 schematically illustrates a banknote processing apparatus according to one embodiment;

FIG. 2 is a flowchart illustrating a flow in a case where one container is taken out;

FIG. 3A illustrates one example of a temporary voucher;

FIG. 3B illustrates one example of an actual voucher;

FIG. 4A is a flowchart illustrating a flow in a case where two containers are taken out;

FIG. 4B is a flowchart illustrating a flow in a case where two containers are taken out; and

FIG. 5 is a flowchart illustrating another flow in a case where the two containers are taken out.

### DESCRIPTION OF EMBODIMENTS

An embodiment of the present invention is hereinafter described with reference to the accompanying drawings. In the following description, a banknote processing apparatus that processes banknotes, as a typical example of a valuable medium processing apparatus according to the present invention is described.

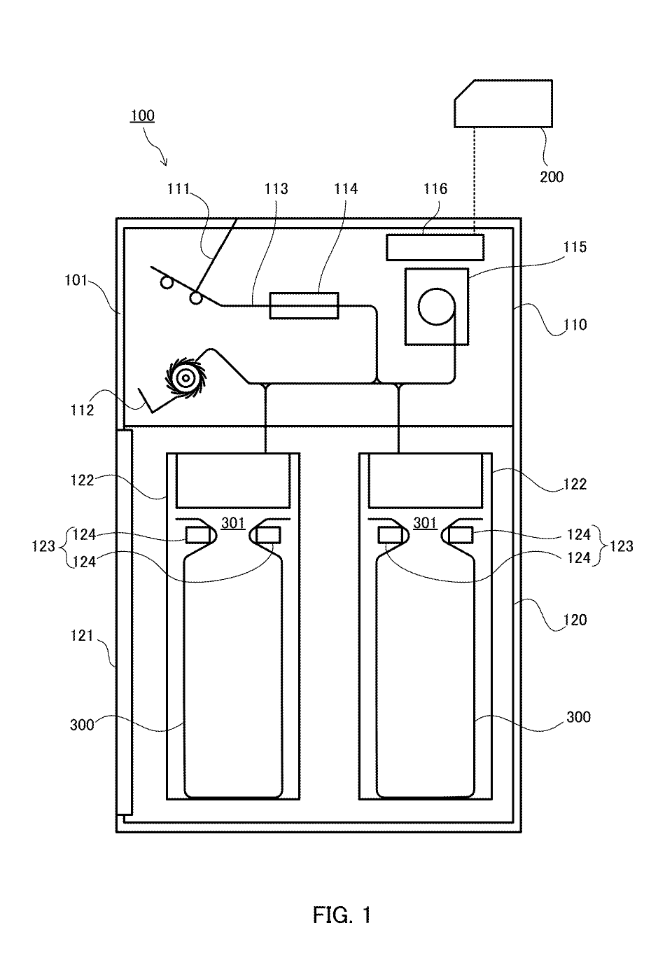

FIG. 1 schematically illustrates a banknote processing apparatus 100 according to this embodiment. The banknote processing apparatus 100 according to this embodiment is an apparatus capable of various banknote processes, such as a banknote deposit process. The banknote processing apparatus 100 is installed in a front area or a back office of a store, such as a bank or a supermarket, for example.

The banknote processing apparatus 100 comprises a housing 101 having a substantially rectangular parallelepiped shape. A left surface of the housing 101 in FIG. 1 is a front surface (i.e., a surface that faces).

An upper unit 110 and a lower unit 120 are stored in the housing 101 in a manner allowing each unit to be drawn forward from the front surface of the housing 101. A lower part of the housing 101 is provided with a lockable door 121 that is opened when the lower unit 120 is drawn forward.

An upper front part of the upper unit 110 is provided with an inlet unit 111 through which banknotes are input into the banknote processing apparatus 100. The inlet unit 111 includes a reception hopper that receives a banknote batch, a banknote feeding mechanism that feeds the banknotes on the reception hopper one by one into the banknote processing apparatus 100. The housing 101 is provided with an opening at a position corresponding to the inlet unit 111. A user can input banknotes into the inlet unit 111 through this opening.

A lower front part of the upper unit 110 is provided with an ejecting unit 112 for ejecting banknotes from the inside of the banknote processing apparatus 100. The ejecting unit 112 includes a stacking unit on which banknotes are stacked, a stacking wheel that feeds the banknotes one by one onto the stacking unit and aligns the banknotes. The housing 101 is provided with an opening at a position corresponding to the ejecting unit 112. The user can take out banknotes from the inside of the ejecting unit 112 through this opening.

A transport unit 113 that transports a banknote is disposed in the upper unit 110. The transport unit 113 includes a transport mechanism, such as a belt. One end of the transport unit 113 is connected to the inlet unit 111. The other end of the transport unit 113 is connected to the ejecting unit 112. The transport unit 113 includes multiple diverter units and diverter paths. These diverter paths are connected to a storing and feeding unit 115 and an attaching unit 122, which are described later.

A recognition unit 114 is disposed at a position adjacent to a part of the transport unit 113 in the upper unit 110. The recognition unit 114 includes various sensors, and recognizes the denomination, fitness and authenticity of a banknote transported by the transport unit 113.

A tape type storing and feeding unit 115 is provided in the upper unit 110. The storing and feeding unit 115 winds a banknote transported by the transport unit 113 around a drum together with tape for storage. The storing and feeding unit 115 rotates the drum in the direction opposite to that for storing, thereby feeding the banknote stored around the drum to the transport unit 113.

A control unit 116 comprising a CPU, a memory device, an information input and output section is disposed in the upper unit 110. The banknote processing apparatus 100 further comprises an operation unit, not illustrated. The control unit 116 controls each device comprised in the banknote processing apparatus 100 according to an instruction input via the operation unit, thereby integrally control the banknote processing apparatus 100.

Two attaching units 122 are provided in the lower unit 120. Containers 300 that store banknotes are detachably attached to the respective attaching units 122, in one-to-one correspondence. The attaching unit 122 stores the container 300 in a state where a port 301 of the container 300 is open. The number of attaching units 122 is not limited to two. The number may be one, or three or more.

In this embodiment, the container 300 is a bag having the port 301, which is an inlet of banknotes, on the top thereof. The container 300 has an adhesive surface on which an adhesive is applied, in proximity to the port 301. The container 300 is configured such that the port 301 can be closed by pasting a part of the container 300 onto the adhesive surface.

Although not specifically limited, the attaching unit 122 has the following configuration, for example. The attaching unit 122 has a sealing mechanism 123 that seals the port 301 of the container 300. The sealing mechanism 123 comprises a pair of holding members 124 that are apart from and opposite to each other. Each holding member 124 holds a container 300 in its position adjacent to a port 301. The part of holding members 124 are movable in a manner capable of becoming close to and apart from each other. The pair of holding members 124 are close to each other, which presses the adhesive surface of the container 300 against a part that is adjacent to the port 301 of the container 300 and other than the adhesive surface to seal the port 301 of the container 300. The sealing mechanism 123 may be configured to be mechanically coupled to the door 121 and to operate in conjunction with an operation of opening the door 121. The sealing mechanism 123 may operate according to an operation instruction from the control unit 116.

The control unit 116 is wiredly or wirelessly connected to a printing apparatus 200 provided outside of the banknote processing apparatus 100. The printing apparatus 200 prints information transmitted from the control unit 116. The banknote processing apparatus 100 and the printing apparatus 200 constitute a banknote processing system. The banknote processing apparatus 100 may comprise the printing apparatus 200 as one of the elements constituting the banknote processing apparatus 100.

In the banknote processing apparatus 100 configured as described above, the deposit process is performed as described below. First, a banknote batch is stacked on the inlet unit 111. The inlet unit 111 then transports banknotes one by one to the transport unit 113. Subsequently, the recognition unit 114 recognizes the denomination of the banknote transported by the transport unit 113. The control unit 116 controls the transport unit 113 according to a recognition result of the recognition unit 114, and transports the banknote to the ejecting unit 112, the storing and feeding unit 115 or the attaching unit 122. The attaching unit 122 inputs the banknote transported to this attaching unit 122 into the container 300.

The control unit 116 stores information about at least one of the type (i.e., denomination) of, the number of, and the total amount (i.e., total value) of banknotes stored in each container 300, for example, the number of banknotes for each denomination. The control unit 116 can calculate the total amount of banknotes stored in each container 300 on the basis of the number of banknotes for each denomination, without storing the total amount.

When the amount of banknotes stored in the container 300 reaches a predetermined amount or a predefined time is reached, a taking-out process of taking out the container 300 from the banknote processing apparatus 100 is started.

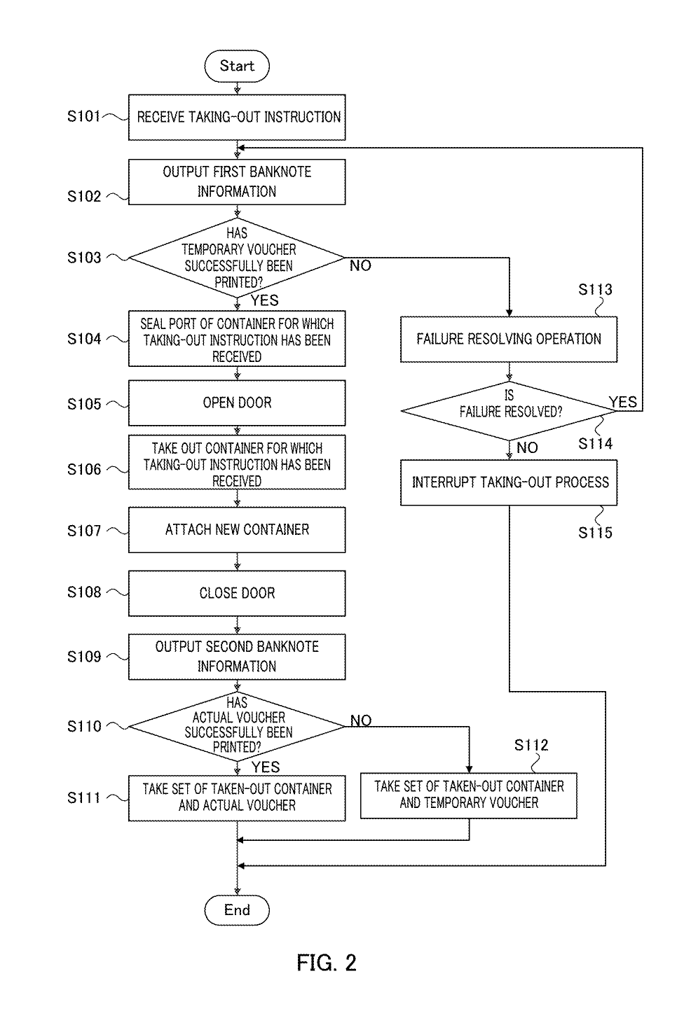

FIG. 2 is a flowchart illustrating an example of a flow of taking out process of taking out one of the two containers 300.

First, an operation unit (not illustrated) comprised in the banknote processing apparatus 100, or an external operation apparatus wiredly or wirelessly connected to the control unit 116 is operated by the operator. The control unit 116 then receives a signal indicating a taking-out instruction for the container 300, from the operation unit or the operation apparatus (S101). In this Specification, the taking-out instruction is an instruction of causing the banknote processing apparatus 100 to perform preparation for detaching the container 300 from the attaching unit 122 and taking out the container 300 from the banknote processing apparatus 100 to the outside.

Upon receipt of the signal indicating the taking-out instruction, the control unit 116 outputs first banknote information that is information about the banknotes stored in the container 300, and transmits the information to the printing apparatus 200 (S102).

The first banknote information corresponds to ‘a first information of the at least two pieces of valuable medium information to be output first’. The first banknote information comprises ‘added information’ indicating that the first banknote information has been output before the container 300 is taken out. The first banknote information comprises information for recognizing the banknote processing apparatus 100 or the operator, information about the number of the banknotes stored in the container 300 for each denomination, and the total amount of these banknotes, and a signature field (described later) (an example of ‘added information’).

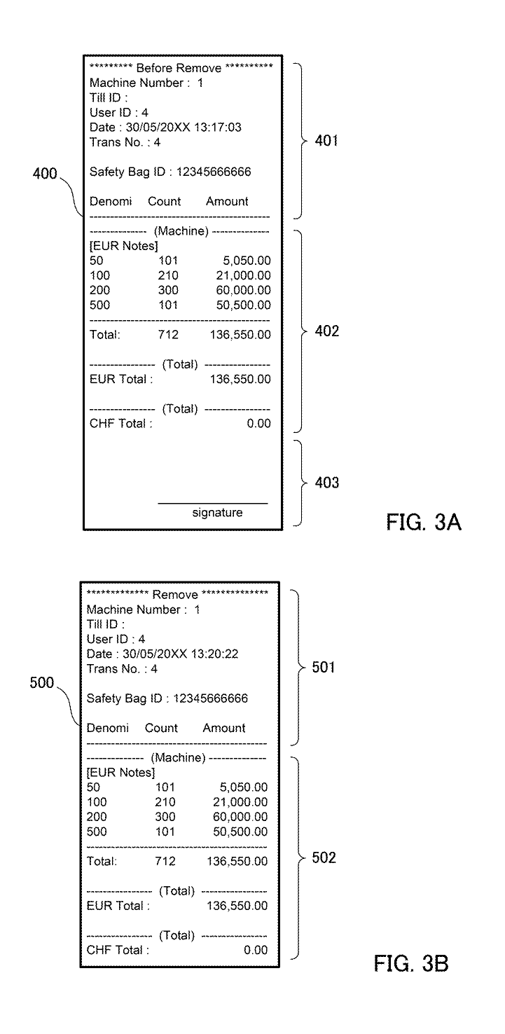

Upon receipt of the first banknote information, the printing apparatus 200 prints a temporary voucher 400 illustrated in FIG. 3A that indicates the content of the first banknote information. A header section 401 that indicates an ID of the banknote processing apparatus 100, an ID of the operator, a printing time is printed on the temporary voucher 400. An indication “Before Remove” in the header section 401 indicates that the temporary voucher 400 is based on the information (first banknote information) output before the container 300 is taken out. That is, this indication is based on a type of the added information. A content section 402 that indicates the number of banknotes, stored in the container 300 that are to be taken out, for each denomination, and the total amount of these banknotes is printed on the temporary voucher 400. A signature field 403 is printed on the temporary voucher 400. The signature field 403 is based on a type of the added information.

When the control unit 116 confirms the success of printing the temporary voucher 400 (YES in S103), this section operates the sealing mechanism 123 to seal the port 301 of the container 300 that is to be taken out (S104). A case where the success of printing the temporary voucher 400 is not confirmed (NO in S103) is described later.

Subsequently, the control unit 116 unlocks the door 121. The operator opens the door 121 (S105).

Subsequently, the operator detaches the container 300, which is to be taken out, from the attaching unit 122, and takes out the container 300 from the housing 101 (S106).

Subsequently, the operator attaches a new container 300 to the attaching unit 122 in a state where the port 301 is open (S107).

Subsequently, the operator closes the door 121 (S108). The control unit 116 locks the door 121.

Lastly, the control unit 116 outputs second banknote information that is information about the banknotes stored in the taken-out container 300, and transmits the information to the printing apparatus 200 (S109). The second banknote information corresponds to ‘a second information of the at least two pieces of valuable medium information to be output subsequently’. The second banknote information comprises information indicating that the second banknote information has been output after the container 300 is taken out (a type of “added information”). The second banknote information further comprises information for recognizing the banknote processing apparatus 100 or the operator, and information about the number of the banknotes stored in the container 300 for each denomination, and the total amount of these banknotes.

Upon receipt of the second banknote information, the printing apparatus 200 prints an actual voucher 500 illustrated in FIG. 3B that indicates the content of the second banknote information. A header section 501 that indicates the ID of the banknote processing apparatus 100, the ID of the operator, a printing time is printed on the actual voucher 500. An indication “Remove” in the header section 501 indicates that the actual voucher 500 is based on the information (second banknote information) output after the container 300 is taken out. That is, this indication is based on a type of the added information. A content section 502 that indicates the number of banknotes, stored in the container 300 that are to be taken out, for each denomination, and the total amount of these banknotes is printed on the actual voucher 500. The content of the content section 502 of the actual voucher 500 is the same as the content of the content section 402 of the temporary voucher 400.

After the operator confirms the success of printing the actual voucher 500 (YES in S110), the operator combines the taken-out container 300 and the actual voucher 500 as a set, and brings back the set (S111), and the taking-out operation is finished.

If the printing of the actual voucher 500 has not succeeded (NO in S110), the operator combines the taken-out container 300 and the temporary voucher 400 as a set, and brings back the set (S112). At this time, the operator signs in the signature field 403 on the temporary voucher 400. Alternatively, a manager signs in the signature field 403 on the temporary voucher 400 brought back with the taken-out container 300. The taking-out operation is thus finished.

By performing the taking-out operation as described above, the temporary voucher 400 can be preliminarily printed. Consequently, in case a failure occurs in the banknote processing apparatus 100 or the printing apparatus 200 during the taking-out operation and the actual voucher 500 cannot be printed (NO in S110), the container 300 and the temporary voucher 400 can be combined as a set to take the set to the cash center. The deposit process can be performed in the cash center on the basis of the content of the temporary voucher 400. Therefore, an useless charge due to the banknote collecting agency being kept standby until the failure in the banknote processing apparatus 100 is resolved can be prevented from occurring.

Furthermore, the signature field 403, which is the field for allowing the operator or the manager to make a signature therein in order to guarantee the content indicated in the content section 402, is printed on the temporary voucher 400. The signature by the operator or the manager functions as assurance information that guarantees the content of the temporary voucher 400, i.e., the content of the first banknote information. Consequently, even though the temporary voucher 400 with the signature having already been made in the signature field 403 is printed before the container 300 is taken out, the content of the banknotes stored in the container 300 can be guaranteed. Instead of the signature field 403, a field for allowing the operator or the manager to make a mark (stamp a seal) indicating that the content of the first banknote information is guaranteed may be printed.

If the printing of the temporary voucher 400 has not succeeded (NO in S103), an operation of resolving the failure by the operator is performed, the failure preventing the temporary voucher 400 from being printed (S113).

If the failure is resolved (YES in S114), the control unit 116 outputs the first banknote information again (S102). The subsequent flow is as described above.

If the failure is not resolved (NO in S114), the control unit 116 interrupts the taking-out process (S115) and finishes the taking-out operation.

Consequently, the banknote processing apparatus 100 in this embodiment can resolve the cause of preventing the temporary voucher 400 from being printed, at an early stage of the taking-out operation, even if the temporary voucher 400 cannot appropriately be printed. Therefore, the standby time of the collecting agency can be minimized, which can in turn minimize the increase in the charge of the collecting agency.

The banknote processing apparatus 100 according to this embodiment can prevent occurrence of a state where the container 300 has been taken out even without the actual voucher 500 and even further without the temporary voucher 400. In other words, a situation can be prevented where since the voucher on which the information about the stored banknotes is written is absent, the container 300 incapable of transitioning to the deposit process occurs in the cash center.

The output timing of the first banknote information is not limited to a time after reception of the signal indicating the taking-out instruction. For example, the timing may be, for example, a time before the operation of the sealing mechanism 123, a time when the operation is started, during the operation, a time after the operation (after completion of sealing), or the like. The output timing of the second banknote information is not limited to a time after the door 121 is locked. For example, the timing may be a time after the sealing mechanism 123 is operated (after completion of sealing), a time when or after the door 121 is unlocked, or a time after the door 121 is opened. In a case where the attaching unit 122 comprises a sensor that detects whether the container 300 is attached or not, the second banknote information may be output when the sensor detects that the container 300 is detached from the attaching unit 122.

The preparation for detaching the container 300 from the attaching unit 122 and taking out the container 300 from the banknote processing apparatus 100 to the outside may be unlocking of the door of the lower unit. In a case where the attaching unit 122 is provided with a limitation mechanism that fixes the container 300 to the attaching unit 122, the preparation may be unfixing of the container 300 fixed by the limitation mechanism of the attaching unit 122. In a case where the attaching unit 122 can be taken out to the outside from the lower unit and comprises a limitation mechanism for limiting taking-out, the preparation may be release of the limitation mechanism that limits the taking-out of the attaching unit 122. Completion of the preparation for detaching the container 300 from the attaching unit 122 and then taking out the container 300 from the banknote processing apparatus 100 to the outside can be regarded that the taking-out of the container 300 is permitted.

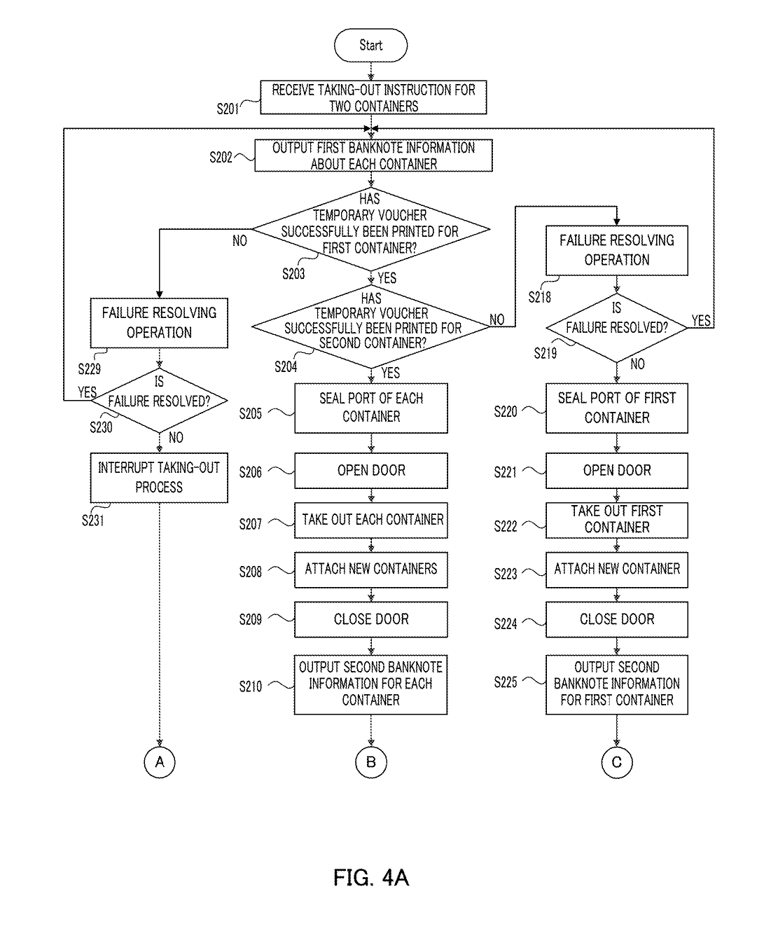

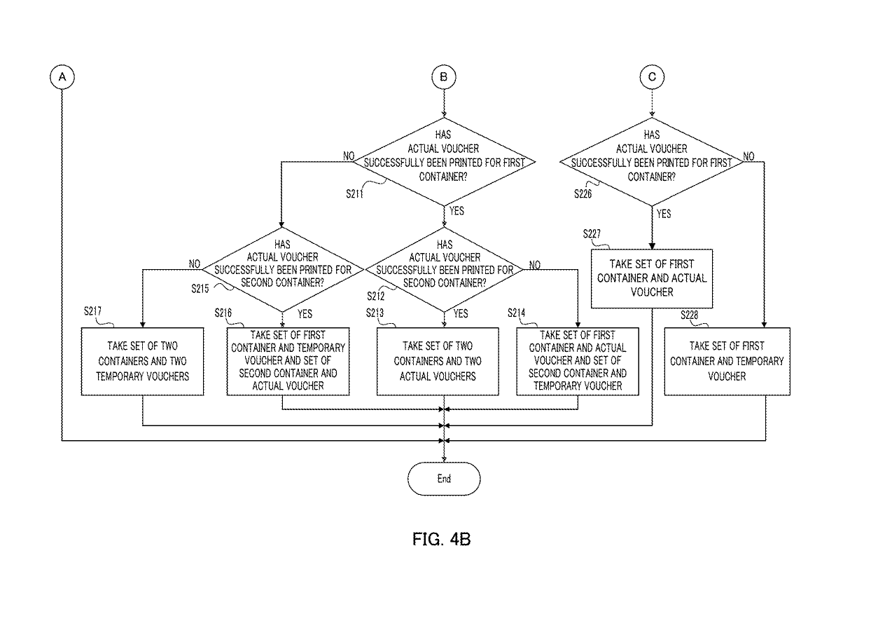

Subsequently, referring to FIG. 4A and FIG. 4B, the flow of the taking-out process of taking out both the two containers 300 is described.

First, an operation unit (not illustrated) comprised in the banknote processing apparatus 100, or an external operation apparatus wiredly or wirelessly connected to the control unit 116 is operated by the operator. The control unit 116 then receives a signal indicating a taking-out instruction for the two containers 300, from the operation unit or the operation apparatus (S201).

Upon receipt of the signal indicating the taking-out instruction, the control unit 116 individually outputs first banknote information that is information about the banknotes stored in each container 300, and transmits the information to the printing apparatus 200 (S202).

The first banknote information comprises the information as described above.

Upon receipt of the individual first banknote information about each container 300, the printing apparatus 200 individually prints the temporary voucher 400 for each container 300. The content of the temporary voucher 400 for each container 300 is analogous to the content of the temporary voucher 400 described above.

When the control unit 116 confirms the success of printing the temporary voucher 400 for each container 300 (YES in S203 and S204), this section operates the sealing mechanism 123 to seal the port 301 of each container 300 (S205). A case where the success of printing the temporary voucher 400 for the first or second container 300 is not confirmed (NO in S203 or 204) is described later.

Subsequently, the control unit 116 unlocks the door 121. The operator opens the door 121 (S206).

Subsequently, the operator detaches the two containers 300 from the attaching units 122, and takes out the containers 300 from the housing 101 (S207).

Subsequently, the operator attaches two new containers 300 to the respective attaching units 122 in a state where the ports are open (S208).

Subsequently, the operator closes the door 121 (S209). The control unit 116 locks the door 121.

Lastly, the control unit 116 individually outputs second banknote information that is information about the banknotes stored in each container 300, and transmits the information to the printing apparatus 200 (S210).

The second banknote information comprises the information as described above.

Upon receipt of the individual second banknote information about each container 300, the printing apparatus 200 prints the actual voucher 500 for each container 300. The content of the actual voucher 500 for each container 300 is analogous to the content of the actual voucher 500 described above.

If the operator confirms success of printing of the actual vouchers 500 for the first and second containers 300 (YES in S211 and S212), the operator combines, as a set, the two containers 300 and total two actual vouchers 500 for the respective containers 300 in one-to-one correspondence, and brings back the set (S213). The taking-out operation is thus finished.

If printing of the actual voucher 500 for the first container 300 has succeeded (YES in S211) but printing of the actual voucher 500 for the second container 300 has not succeeded (NO in S212), the taking-out operation is finished as follows. That is, the operator brings back the set of the first container 300 and the actual voucher 500 for this first container 300, and the set of the second container 300 and the temporary voucher 400 for this second container 300 (S214), thus finishing the taking-out operation.

If printing of the actual voucher 500 for the first container 300 has not succeeded (NO in S211) but printing of the actual voucher 500 for the second container 300 has succeeded (YES in S215), the taking-out operation is finished as follows. That is, the operator brings back the set of the first container 300 and the temporary voucher 400 for this first container 300, and the set of the second container 300 and the actual voucher 500 for this second container 300 (S216), thus finishing the taking-out operation.

If printing of the actual vouchers 500 for the respective containers 300 has not succeeded (NO in S211 and S215), the taking-out operation is finished as follows. That is, the operator combines the two containers 300 and total two temporary vouchers 400 for the respective containers 300 in one-to-one correspondence as a set, and brings back the set (S217), thus finishing the taking-out operation.

Subsequently, a flow in a case where printing of the temporary voucher 400 for the first container 300 has succeeded (YES in S203) but printing of the temporary voucher 400 for the second container 300 has not succeeded (NO in S204) is described. In this case, an operation of resolving the failure that prevents the temporary voucher 400 from being printed is performed by the operator or the like (S218).

If the failure is resolved (YES in S219), the control unit 116 outputs the first banknote information again (S202). The subsequent flow is as described above.

If the failure is not resolved (NO in S219), that is, if printing of the temporary voucher 400 for the first container 300 has succeeded but printing of the temporary voucher 400 for the second container 300 has not succeeded, the taking-out operation is continued as follows.

First, the control unit 116 seals the port 301 of the first container 300 for which the temporary voucher 400 has been printed (S220).

Subsequently, the control unit 116 unlocks the door 121. The operator opens the door 121 (S221).

Subsequently, the operator detaches the first container 300 from the attaching unit 122, and takes out the container 300 from the housing 101 (S222).

Subsequently, the operator attaches a new container 300, in a state where the port is open, to the attaching unit 122 to which the first container 300 was attached (S223).

Subsequently, the operator closes the door 121 (S224). The control unit 116 locks the door 121.

Lastly, the control unit 116 outputs the second banknote information, which is information about the banknotes stored in the first container 300, and transmits the information to the printing apparatus 200 (S225).

Upon receipt of the second banknote information about the first container 300, the printing apparatus 200 prints the actual voucher 500 for the first container 300.

If the operator confirms success of printing of the actual voucher 500 for the first container 300 (YES in S226), the operator combines, as a set, the first container 300 and the actual voucher 500 for this first container 300, and brings back the set (S227). The taking-out operation is thus finished.

In this case, the second container 300 is not taken out from the banknote processing apparatus 100. After the failure that prevents the temporary voucher 400 for the second container 300 from being printed is resolved, the taking-out operation for the second container 300 is performed anew. During this operation, the operator is not required to be stood by. Consequently, the charge accompanying the operator's standby can be prevented from occurring.

If printing of the actual voucher 500 for the first container 300 has not succeeded (NO in S226), the taking-out operation is finished as follows. That is, the operator brings back the set of the first container 300 and the temporary voucher 400 for this first container 300 (S228), thus finishing the taking-out operation.

Also in this case, the second container 300 is not taken out from the banknote processing apparatus 100. After the failure that prevents the temporary voucher 400 for the second container 300 from being printed is resolved, the taking-out operation for the second container 300 is performed anew. During this operation, the operator is not required to be stood by. Consequently, the charge accompanying the operator's standby can be prevented from occurring.

If the printing of the temporary voucher 400 for the first container 300 has not succeed (NO in S203), an operation of resolving the failure by the operator or the like is performed, the failure preventing the temporary voucher 400 from being printed (S229).

If the failure is resolved (YES in S230), the control unit 116 outputs the first banknote information again (S202). The subsequent flow is as described above.

If the failure is not resolved (NO in S230), the control unit 116 interrupts the taking-out process (S231) and finishes the taking-out operation.

In this case, the two containers 300 are not taken out from the banknote processing apparatus 100. After the failure that prevents the temporary voucher 400 from being printed is resolved, the taking-out operation for the two containers 300 is performed anew. During this operation, the operator is not required to be stood by. Consequently, the charge accompanying the operator's standby can be prevented from occurring.

In the case where taking-out operation is performed for the containers 300 on the basis of such a flow, even if the actual voucher 500 cannot be printed for one or both of the two containers 300, the temporary voucher 400 for the container(s) 300 can be preliminarily printed. Consequently, a state where any one or both of the containers 300 have been taken out even without the actual voucher 500 and even further without the temporary voucher 400 can be prevented from occurring. That is, the situation can be prevented where since the voucher on which the information about the stored banknotes is written is absent, the container 300 that cannot be subjected to the deposit process in the cash center or the like occurs.

The above flow assumes that the temporary vouchers 400 are individually printed and the actual vouchers 500 are individually printed, for both the two containers 300. Alternatively, it may be assumed that a single common temporary voucher 400 and a single common actual voucher 500 for both the two containers 300 are printed. For example, the number of banknotes for each denomination stored in the first container 300 and the total amount thereof, and the number of banknotes for each denomination stored in the second container 300 and the total amount thereof may be printed on a single temporary voucher 400 and a single actual voucher 500. Alternatively, values obtained by totalizing the numbers of banknotes for each denomination stored in the two containers 300 and the total amounts thereof may be printed on a single temporary voucher 400 and a single actual voucher 500.

Alternatively, a single common temporary voucher 400 for the two containers 300, and total two actual vouchers 500 individually for the respective two containers 300 in one-to-one correspondence may be printed. In an opposite manner, total two temporary vouchers 400 individually for the respective two containers 300 in one-to-one correspondence, and a single common actual vouchers 500 for the two containers 300 may be printed.

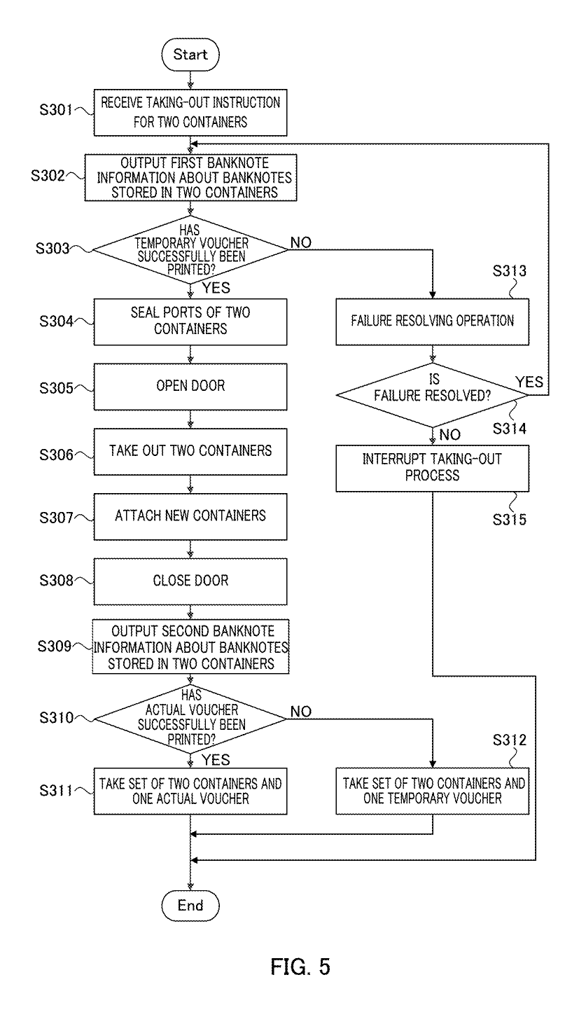

Referring to FIG. 5, a flow of such a taking-out process, that is, a case where the two containers 300 are taken out and the single temporary voucher 400 and the single actual voucher 500 are printed, is described.

First, an operation unit (not illustrated) comprised in the banknote processing apparatus 100, or an external operation apparatus wiredly or wirelessly connected to the control unit 116 is operated by the operator. The control unit 116 then receives a signal indicating a taking-out instruction for the two containers 300, from the operation unit or the operation apparatus (S301).

Upon receipt of the signal indicating the taking-out instruction, the control unit 116 outputs first banknote information that is information about the banknotes stored in the two containers 300, and transmits the information to the printing apparatus 200 (S302). The first banknote information described here is information about a combination of the banknotes stored in the first container 300 and the banknotes stored in the second container 300. That is, the first banknote information comprises, for example, the sum of the total amount of banknotes stored in the first container 300 and the total amount of banknotes stored in the second container 300. Alternatively, the first banknote information comprises the sum of the number of banknotes for a certain denomination stored in the first container 300 and the number of banknotes for the certain denomination stored in the other container 300. The other points are as described above.

Upon receipt of the first banknote information, the printing apparatus 200 prints the temporary voucher 400 that indicates the content of the first banknote information. Since the temporary voucher 400 has already been described, detail description thereof is omitted here.

When the control unit 116 confirms the success of printing the temporary voucher 400 (YES in S303), this section operates the sealing mechanisms 123 to seal the ports 301 of the two containers 300 (S304). A case where the success of printing the temporary voucher 400 is not confirmed (NO in S303) is described later.

Subsequently, the control unit 116 unlocks the door 121. The operator opens the door 121 (S305).

Subsequently, the operator detaches the two containers 300 from the respective attaching units 122, and takes out the containers 300 from the housing 101 (S306).

Subsequently, the operator attaches two new containers 300 to the respective attaching units 122 in a state where the ports are open (S307).

Subsequently, the operator closes the door 121 (S308). The control unit 116 locks the door 121.

Lastly, the control unit 116 outputs the second banknote information, which is information about the banknotes stored in the two containers 300, and transmits the information to the printing apparatus 200 (S309). The second banknote information described here is information about a combination of the banknotes stored in the first container 300 and the banknotes stored in the second container 300. That is, the second banknote information comprises, for example, the sum of the total amount of banknotes stored in the first container 300 and the total amount of banknotes stored in the second container 300. Alternatively, the second banknote information comprises the sum of the number of banknotes for a certain denomination stored in the first container 300 and the number of banknotes for the certain denomination stored in the other container 300. The other points are as described above.

Upon receipt of the second banknote information, the printing apparatus 200 prints the actual voucher 500 that indicates the content of the second banknote information. Since the actual voucher 500 has already been described, detail description thereof is omitted here.

After the operator confirms the success of printing the actual voucher 500 (YES in S310), the operator combines the two containers 300 and a single actual voucher 500 as a set, and brings back the set (S311), and the taking-out operation is finished.

If the printing of the actual voucher 500 has not succeeded (NO in S310), the operator combines the two containers 300 and a single temporary voucher 400 as a set, and brings back the set (S312). At this time, the operator signs in the signature field 403 on the temporary voucher 400. Alternatively, the manager signs in the signature field 403 on the temporary voucher 400 brought back with the taken-out two containers 300. The taking-out operation is thus finished.

If the printing of the temporary voucher 400 has not succeed (NO in S303), an operation of resolving the failure by the operator is performed, the failure preventing the temporary voucher 400 from being printed (S313).

If the failure is resolved (YES in S314), the control unit 116 outputs the first banknote information again (S302). The subsequent flow is as described above.

If the failure is not resolved (NO in S314), the control unit 116 interrupts the taking-out process (S315) and finishes the taking-out operation.

If the banknote processing apparatus 100 is operated as described above, only a single temporary voucher 400 and a single actual voucher 500 are required to be printed. Consequently, if there is no need to discriminate, from each other, the two containers 300 taken out from the single banknote processing apparatus 100 by one taking-out operation, an advantage capable of performing the taking-out operation more simply is achieved.

The container 300 is not limited to a bag, and may be a stacking type containing area in which multiple banknotes are stored in a stacked state, or a winding type cassette in which multiple banknotes are stored in a state of being wound around a rotation body.

The banknote processing apparatus 100 may comprise multiple banknote containing areas where banknotes can be stored and taken out and which allow the banknote deposit process, dispensation process and the like to be performed.

In the example described above, each of the temporary voucher 400 and the actual voucher 500 is a voucher on which only characters and numerals are printed. It is a matter of course that a part of or the entire information indicated by the characters and numerals may be replaced with a barcode.

On the temporary voucher 400 or the actual voucher 500, the content of a failure or various errors occurring in the banknote processing apparatus 100 at a stage of printing the voucher may be printed. The content thereof can be represented in a natural language or as predetermined codes. Such a configuration allows a person viewing the temporary voucher 400 or the actual voucher 500 to recognize correctly the content of the failure or various errors occurring in the banknote processing apparatus 100 and to address the failure or errors quickly.

If the actual voucher 500 has a part different from the temporary voucher 400 in comparison with the content, there may be a mark indicating that the actual voucher 500 has the content different from the temporary voucher 400 at this part on the actual voucher 500. This configuration can provide secure recognition of which part of the actual voucher 500 is different from the temporary voucher 400.

Instead of the printing apparatus 200, a mobile device, such as a smartphone or a tablet terminal, may be wiredly or wirelessly connected to the control unit 116 to constitute the banknote processing system. In this case, instead of printing of the temporary voucher 400 and the actual voucher 500, the content of the temporary voucher 400 and the actual voucher 500 may be displayed on the screen of a mobile device. In this case, by referring to the first banknote information or the second banknote information displayed on the screen of the mobile device, the process of depositing banknotes in the brought-back container 300 can be performed in the cash center or the like.

In this case, the signature field 403 may be displayed on the screen of the mobile device, thus allowing a signature to be written through the screen. Alternatively, a checkbox may be displayed on the screen of the mobile device; indication may be made by checking the checkbox.

Alternatively, a memory device comprised in such a mobile device or a memory medium, such as a USB memory, may receive the first banknote information and the second banknote information from the control unit 116, and store the received pieces of information. These pieces of information are read in the cash center or the like, and are printed as the temporary voucher 400 and the actual voucher 500 or displayed on the screen of an information processing apparatus, and are provided for the deposit process.

It is a matter of course that the valuable media to be processed by the valuable medium processing apparatus according to the present invention are not necessarily banknotes. The media may be paper sheets, such as checks or coupons, coins or the like. That is, the valuable medium processing apparatus according to the present invention is not limited to the banknote processing apparatus. The apparatus may process valuable media other than banknotes.

### INDUSTRIAL APPLICABILITY

The present invention is preferably used as the valuable medium processing apparatus and the valuable medium processing system.

### REFERENCE SIGNS LIST

100 Banknote processing apparatus
101 Housing
110 Upper unit
111 Inlet unit
112 Ejecting unit
113 Transport unit
114 Recognition unit
115 Storing and feeding unit
116 Control unit
120 Lower unit
121 Door
122 Attaching unit
123 Sealing mechanism
124 Holding member
200 Printing apparatus
300 Container
301 Port
400 Temporary voucher
500 Actual voucher
401, 501 Header section
402, 502 Content section
403 Signature field

1. A valuable medium processing apparatus, comprising:
an attaching unit to which a container for storing valuable media is to be detachably attached; and
a control unit that receives a taking-out instruction for the container, and sequentially outputs at least two pieces of valuable medium information about the valuable media stored in the container.

2. The valuable medium processing apparatus according to claim 1,
wherein a first information of the at least two pieces of valuable medium information to be output first comprises information about at least one of a type of, a number of, and a total value of the valuable media stored in the container.

3. The valuable medium processing apparatus according to claim 1,
wherein the control unit outputs a first information of the at least two pieces of valuable medium information to be output first, before the container is taken out.

4. The valuable medium processing apparatus according to claim 1,
wherein on condition that a first information of the at least two pieces of valuable medium information to be output first is output, preparation to detach the container from the attaching unit and take out the container is performed by the control unit.

5. The valuable medium processing apparatus according to claim 1,
wherein a second information of the at least two pieces of valuable medium information to be output subsequently comprises information about at least one types of, the number of, and a total value of the valuable media stored in the container.

6. The valuable medium processing apparatus according to claim 1,
wherein the control unit outputs a second information of the at least two pieces of valuable medium information to be output subsequently, after the container is taken out.

7. The valuable medium processing apparatus according to claim 1,
wherein a second information of the at least two pieces of valuable medium information to be output subsequently comprises at least a part of information comprised in a first information of the at least two pieces of valuable medium information to be output first.

8. The valuable medium processing apparatus according to claim 1,
wherein a first information of the at least two pieces of valuable medium information to be output first comprises added information that is not comprised in a second information of the at least two pieces of valuable medium information to be output subsequently

9. The valuable medium processing apparatus according to claim 1,
wherein a second information of the at least two pieces of valuable medium information to be output subsequently comprises added information that is not comprised in a first information of the at least two pieces of valuable medium information to be output first.

10. The valuable medium processing apparatus according to claim 1,
wherein a first information of the at least two pieces of valuable medium information to be output first comprises added information that is not comprised in a second information of the at least two pieces of valuable medium information to be output subsequently, and
the second information comprises added information that is not comprised in the first information.

11. The valuable medium processing apparatus according to claim 8,
wherein the added information is comprised in the first information of valuable medium information to be output first, and
the control unit makes a field or an indication for allowing assurance information to be written or marked.

12. The valuable medium processing apparatus according to claim 1,
wherein the attaching unit comprises a sealing mechanism that seals a port of the container, and
the control unit issues an instruction for operating the sealing mechanism, after receiving the taking-out instruction.

13. The valuable medium processing apparatus according to claim 12,
wherein the control unit outputs a first information of the at least two pieces of valuable medium information, before the sealing mechanism is operated.

14. The valuable medium processing apparatus according to claim 12,
wherein the control unit outputs a second information of the at least two pieces of valuable medium information, after sealing of the port by the sealing mechanism is completed.

15. The valuable medium processing apparatus according to claim 1, comprising
a plurality of the attaching units.

16. The valuable medium processing apparatus according to claim 15,
wherein the control unit outputs the valuable medium information related to the container that is a target of the taking-out instruction.

17. The valuable medium processing apparatus according to claim 15,
wherein the valuable medium information pertains to the valuable media stored in all the containers that are targets of the taking-out instruction.

18. A valuable medium processing system, comprising:
the valuable medium processing apparatus according to claim 1; and
a printing apparatus that prints the valuable medium information.
